(19) United States
(12) Patent Application Publication
(10) Pub. No.: US 2019/0039890 A1
(43) Pub. Date: Feb. 7, 2019

(54) HIGH PURITY HYDROGEN PRODUCTION DEVICE AND HIGH PURITY HYDROGEN PRODUCTION METHOD

(71) Applicant: KOREA INSTITUTE OF SCIENCE AND TECHNOLOGY, Seoul (KR)

(72) Inventors: Hyung Chul HAM, Seoul (KR); Byeong Wan KWON, Seoul (KR); Chan Hyun LEE, Seoul (KR); Joohyeng OH, Seoul (KR); Seong Cheol JANG, Seoul (KR); Sun-Hee CHOI, Seoul (KR); Hyun Seo PARK, Seoul (KR); Chang Won YOON, Seoul (KR); Jonghee HAN, Seoul (KR); Sung Pil YOON, Seoul (KR); Suk Woo NAM, Seoul (KR); Ki Bong LEE, Seoul (KR)

(21) Appl. No.: 16/045,755

(22) Filed: Jul. 26, 2018

(30) Foreign Application Priority Data
Aug. 1, 2017 (KR) 10-2017-0097714
Apr. 4, 2018 (KR) 10-2018-0039227

(51) Int. Cl. C01B 3/48; B01J 8/04; C01B 3/56; B01J 23/63; B01J 20/04; B01D 53/02

(52) U.S. Cl. CPC C01B 3/48; B01D 2257/504; B01J 8/0496; C01B 3/56; B01J 23/63; B01J 20/043; B01D 53/02; B01J 2208/00309; C01B 2203/0238; C01B 2203/0283; C01B 2203/0425; C01B 2203/0475; C01B 2203/0844; C01B 2203/1064; C01B 2203/1241; B01D 2253/112; B01D 2256/16; B01J 8/0492

(57) ABSTRACT

A hydrogen production device is provided. The device comprises: a dry reforming reaction unit for directly reacting methane and carbon dioxide in biogas to produce a synthesis gas containing hydrogen; and a gas shift unit for reacting carbon monoxide in the synthesis gas produced in the dry reforming reaction unit with water vapor to produce carbon dioxide and hydrogen, and for capturing the produced carbon dioxide.

### DESCRIPTION ABOUT NATIONAL SUPPORT RESEARCH AND DEVELOPMENT

This study was supported by following national research projects:

Ministry of Trade, Industry and Energy, Republic of Korea (Development of original technology in perovskite catalyst for reforming biogas (containing CO₂) and 1 L/min scale hydrogen production system, Project No. 1415148422) under the superintendence of Korea Institute of Science and Technology; and

Ministry of Science, ICT and Future Planning, Republic of Korea (Study of material for elements for high temperature fuel cells with long life and low market price using alternative fuel, Project No. 1711042029) under the superintendence of Korea Institute of Science and Technology.

### CROSS-REFERENCE TO RELATED APPLICATION

This application claims priority to Korean Patent Applications No. 10-2017-0097714, filed on Aug. 1, 2017 and No. 10-2018-0039227, filed on Apr. 4, 2018, and all the benefits accruing therefrom under 35 U.S.C. § 119, the contents of which in its entirety are herein incorporated by reference

### BACKGROUND OF THE INVENTION

### Field of the Invention

The present invention relates to a high purity hydrogen production device and a high purity hydrogen production method, particularly to a high purity hydrogen production device and a high purity hydrogen production method using biogas.

### Description of the Related Art

Korea is an energy resource poor country and imports a lot of energy resources. The country is ranked in the top 10 in the world for energy consumption and its economy is greatly influenced by the world oil price. Thus, it is urgent to develop and use renewable energy capable of sustainable growth in order to secure its energy supply. Korea is also the ninth largest greenhouse gas emitter in the world and is under increasing global pressure to curb its greenhouse gas emission.

Thus, hydrogen energy is emerging as a future clean energy that can solve both environmental problems such as global warming and energy dependence at the same time. Methods for producing hydrogen include a method of using fossil fuel such as natural gas and a method of producing hydrogen from biomass such as sewage sludge or food waste.

Among them, it is advantageous to produce renewable energy such as biogas (including 55-70% of methane and 30-45% of carbon dioxide) from biomass, in terms of economics.

Although various processes are used for hydrogen production from biogas, steam reforming is most widely used.

However, the steam reforming selectively removes the carbon dioxide contained in biogas, which requires energy consumption, and thus it is disadvantageous in terms of efficiency. In order to overcome this problem, in a recent steam reforming method, after carbon dioxide in biogas is selectively removed, methane gas reacts with water vapor in a methane steam reforming reactor to produce a synthesis gas of hydrogen and carbon monoxide, and then, the carbon monoxide is converted to carbon dioxide in a water-gas reactor by a catalyst. Finally, carbon monoxide is removed from the synthesis gas in a selective shift reactor, and then, carbon dioxide is separated by a pressure swing adsorption (PSA) process, etc. to finally produce hydrogen (FIG. 1). However, this method has a complicated process and requires a lot of additional facilities, which limits the utilization of space and causes high costs for the separation process.

According to Patent Literature 1, methane gas and water vapor can be reformed to produce hydrogen. Although the corresponding device is useful as a small-scale hydrogen production device for polymer electrolyte fuel cells, it requires selective removal of carbon dioxide in large-scale reforming or biogas reforming, and causes high energy consumption and costs for carbon dioxide removal because its hydrogen production efficiency greatly depends on carbon dioxide removal efficiency. In addition, this method has a complicated process and requires a lot of additional facilities, which limits the utilization of space and causes high costs for the separation process.

Thus, it is necessary to develop a new hydrogen production device capable of producing hydrogen of high purity while minimizing the generation of carbon dioxide.

### CITATION LIST

### Patent Literature

Patent Literature 1: Korean Patent Application No. 10-2011-0033460

Patent Literature 2: Korean Patent No. 10-1629689

### SUMMARY OF THE INVENTION

An object of the present invention is to provide a high purity hydrogen production device and a high purity hydrogen production method.

In one embodiment, the present invention provides a hydrogen production device comprising: a dry reforming reaction unit for directly reacting methane and carbon dioxide in biogas to produce a synthesis gas containing hydrogen; and a gas shift unit for reacting carbon monoxide in the synthesis gas produced in the dry reforming reaction unit with water vapor to produce carbon dioxide and hydrogen, and for capturing the produced carbon dioxide.

In one exemplary embodiment, the carbon dioxide captured in the gas shift unit may be supplied to the dry reforming reaction unit to be recycled in the reaction with methane in biogas.

In one exemplary embodiment, the gas shift unit may comprise a hydrogen production catalyst and an adsorbent for capturing carbon dioxide, and wherein the weight ratio of the hydrogen production catalyst and the adsorbent for capturing carbon dioxide may be 1:9 to 9:1.

In one exemplary embodiment, the hydrogen production catalyst may comprise at least one transition metal selected from the group consisting of Cu, Ni, and Fe.

In one exemplary embodiment, the adsorbent for capturing carbon dioxide may comprise an alkali metal double salt-based adsorbent or a hydrotalcite-based adsorbent.

In one exemplary embodiment, the alkali metal double salt-based adsorbent may be an adsorbent prepared by coprecipitation or impregnation process of an alkaline earth metal carbonate, and the hydrotalcite-based adsorbent may be an adsorbent prepared by mixing a chloride represented by any one of the following Formulae 1 to 4 and a carbonate represented by the following Formula 5 and subjecting the resultant to hydrothermal synthesis or coprecipitation process:

(1−x)M(OH)₂ Formula 1

(1−x)M(NO₃)₂ Formula 2

xL(OH)₃ Formula 3

xL(NO₃)₃ Formula 4

(x/2)A₂CO₃ Formula 5

wherein x may be a number of 0.17 to 0.4, M may be selected from the group consisting of magnesium (Mg), zinc (Zn) and nickel (Ni), L may be selected from the group consisting of aluminum (Al), gallium (Ga), iron (Fe) and manganese (Mn), and A may be selected from the group consisting of sodium (Na), potassium (K), rubidium (Rb), cesium (Cs) and francium (Fr).

In one exemplary embodiment, the dry reforming reaction unit may comprise a catalyst comprising a compound represented by the following Formula 6:

Sr_{1-y}Y_{y}TiRuₓO_{3-δ} Formula 6

wherein x is greater than 0 and less than 1, y is greater than 0 and less than 0.1, and δ is 0 or more and 1 or less.

In one exemplary embodiment, the catalyst comprising the compound represented by Formula 6 may achieve a methane conversion rate of 80% or more during an operation period of 60 to 120 hours at a temperature of 700 to 900° C.

In one exemplary embodiment, the hydrogen production device may further comprise a heat transfer unit for transferring the waste heat of the dry reforming reaction unit to the gas shift unit, and the heat transfer unit may comprise: a steam generator for producing water vapor; and a preheating unit for preheating the synthesis gas produced in the dry reforming reaction unit.

In one exemplary embodiment, the preheating unit may be operated using the waste heat of the dry reforming reaction unit as a heat source.

In one exemplary embodiment, the hydrogen production device may further comprise a hydrogen gas capturing unit connected to the gas shift unit.

In another embodiment, the present invention provides a method for producing hydrogen by means of a hydrogen production device comprising a dry reforming reaction unit and a gas shift unit, the method comprising: in the dry reforming reaction unit, directly reacting methane and carbon dioxide in biogas to produce a synthesis gas; and in the gas shift unit, reacting carbon monoxide in the synthesis gas produced in the dry reforming reaction unit with water vapor to produce carbon dioxide and hydrogen and capturing the produced carbon dioxide.

In one exemplary embodiment, the carbon dioxide captured from the reaction of carbon monoxide and water vapor may be recycled in the reaction with methane in biogas in the dry reforming reaction unit.

In one exemplary embodiment, the gas shift unit may comprise a hydrogen production catalyst and an adsorbent for capturing carbon dioxide, and wherein the weight ratio of the hydrogen production catalyst and the adsorbent for capturing carbon dioxide may be 1:9 to 9:1.

The hydrogen production device according to one embodiment of the present invention allows to easily recycle carbon dioxide. Thus, it does not require a separate process for removing carbon dioxide and thus can achieve greatly improved process efficiency as compared with conventional processes.

In addition, the hydrogen production device according to one embodiment of the present invention allows the reaction of biogas by dry reforming reaction, which can further improve hydrogen production ability.

In addition, the hydrogen production device according to one embodiment of the present invention removes most carbon dioxide and thus allows to produce high purity hydrogen. Besides, the hydrogen production device and method according to the present invention release almost no carbon dioxide and thus allows to produce hydrogen in an eco-friendly manner.

Thus, the hydrogen production device can be directly applied to a polymer electrolyte membrane fuel cells (PEMFCs), which are low temperature type fuel cells, and can be utilized in various industrial fields.

### BRIEF DESCRIPTION OF THE DRAWINGS

FIG. 1 is a flow chart of a hydrogen production process according to the prior art;

FIG. 2 is a flow chart of a hydrogen production process according to one embodiment of the present invention;

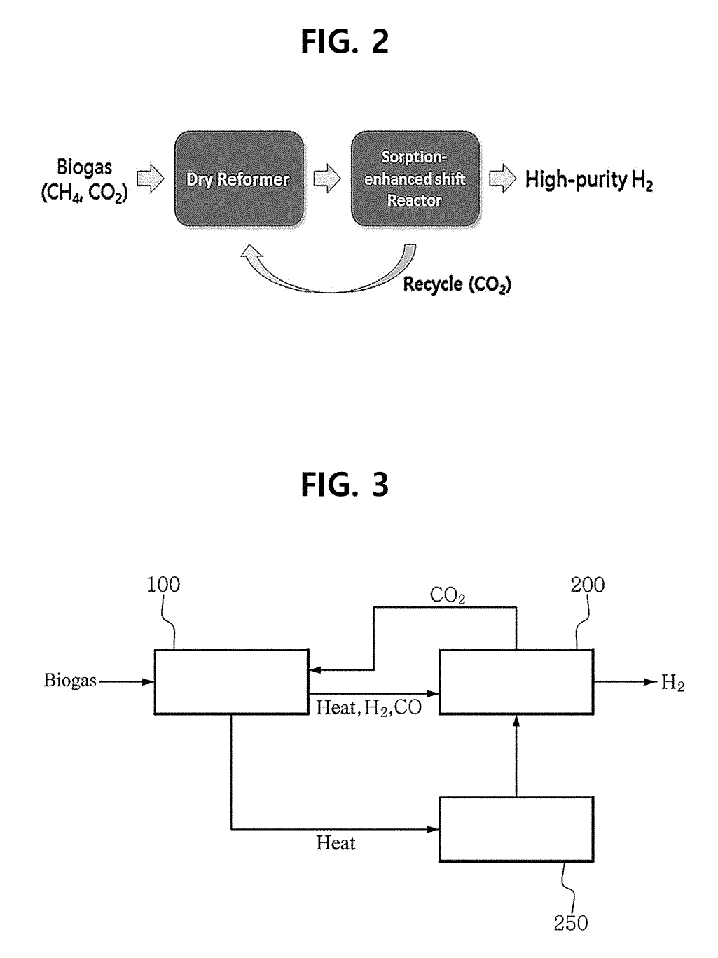

FIG. 3 is a block diagram showing a high purity hydrogen production device according to one embodiment of the present invention;

FIG. 4 is a photograph (left) of the dry reforming unit of a high purity hydrogen production system according to one embodiment of the present invention and a block diagram of the dry reforming unit (right);

FIG. 5 is a block diagram showing a water-gas shift unit of a high purity hydrogen production system according to one embodiment of the present invention;

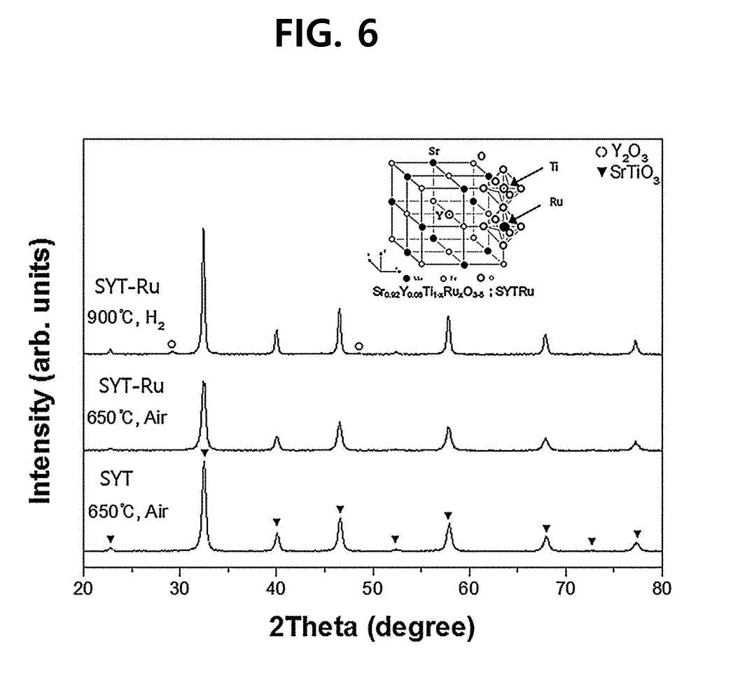

FIG. 6 is a graph showing the dry reforming performance of the catalyst used in the dry reforming reaction unit of the present invention;

FIG. 7 is a graph showing the performance of the gas shift unit (a hydrogen production catalyst and an adsorbent for capturing carbon dioxide) used in one embodiment of the present invention;

FIG. 8A and FIG. 8B are graphs showing the test results of the performance of the gas shift unit (a hydrogen production catalyst and an adsorbent for capturing carbon dioxide) according to the present invention, and a hydrotalcite-based adsorbent was used in both cases (FIG. 8A shows the case where the ratio of the hydrogen production catalyst and the adsorbent for capturing carbon dioxide is 4:1, and FIG. 8B shows the case where the ratio of the hydrogen production catalyst and the adsorbent for capturing carbon dioxide is 1:4);

FIG. 9A is a graph showing the test results of a high purity hydrogen production reactor according to the present invention in which the dry reforming reaction unit and the gas shift unit are filled with a catalyst only; and

FIG. 9B is a graph showing the test results of a high purity hydrogen production reactor according to the present invention in which the dry reforming reaction unit is filled with a catalyst and the gas shift unit is filled with both a catalyst and an adsorbent.

### DETAILED DESCRIPTION OF THE PREFERRED EMBODIMENTS

Hereinafter, embodiments of the present invention will be described in detail with reference to the accompanying drawings. Although the embodiments of the present invention have been described with reference to the accompanying drawings, it is to be understood that the same is by way of example only and is not intended to limit the technical idea, constitution and application of the present invention.

Hydrogen Production Device

A hydrogen production device according to the present invention comprises a dry reforming reaction unit for directly reacting methane and carbon dioxide in biogas to produce a synthesis gas containing hydrogen; and a gas shift unit for reacting carbon monoxide in the synthesis gas produced in the dry reforming reaction unit with water vapor to produce carbon dioxide and hydrogen, and for capturing the produced carbon dioxide. The dry reforming reaction unit of the hydrogen production device of the present invention uses a catalyst optimized for hydrogen production and thus can achieve remarkably improved hydrogen production performance as compared with conventional devices. In addition, the gas shift unit of the hydrogen production device immediately captures carbon dioxide, which allows to maintain the hydrogen production performance in the gas shift unit without deterioration. Thus, the hydrogen production performance can be greatly improved. Hereinafter, we will describe the hydrogen production device in detail.

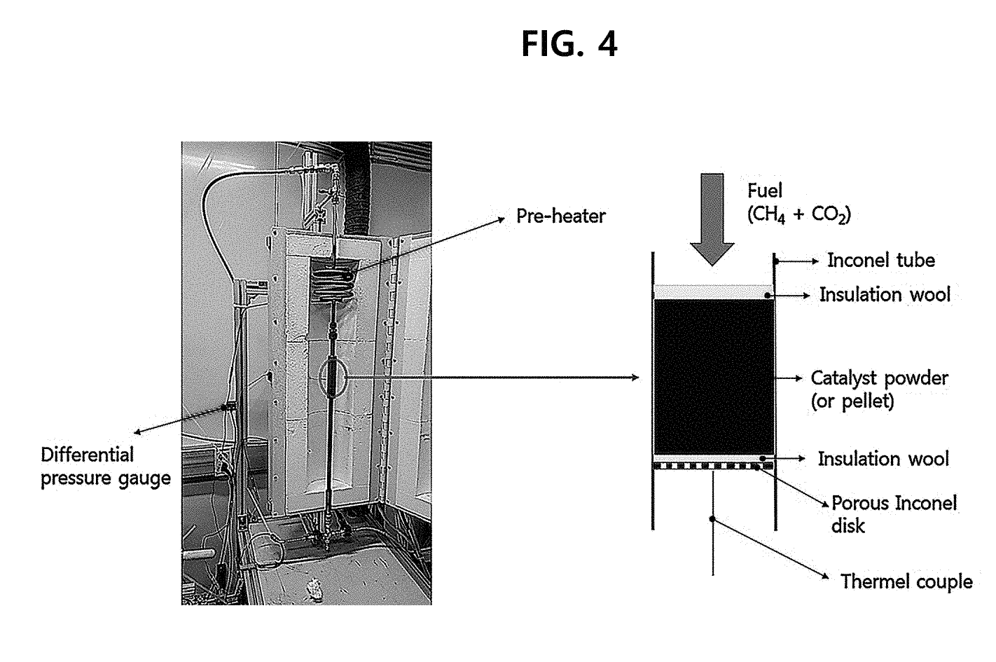

FIG. 3 is a block diagram showing a high purity hydrogen production device according to one embodiment of the present invention.

With reference to FIG. 3, the hydrogen production device comprises a dry reforming reaction unit 100, a gas shift unit 200, and a heat transfer unit 250.

The dry reforming reaction unit 100 is connected to a supply unit (not shown) to which biogas is supplied.

In the dry reforming reaction unit 100, a reaction represented by the following Scheme 1 proceeds.

CH₄+CO₂↔2CO+2H₂(ΔH_{298K}=+247 kJ mol⁻¹) Scheme 1

In general, a hydrogen production device using reforming reaction uses steam reforming reaction because, although dry reforming reaction exhibits superior efficiency to steam reforming, no suitable catalyst for dry reforming reaction has been found, resulting in deposition of carbon, and thus reduces catalyst activity, which decreases the durability of the hydrogen production device. However, the present invention uses a catalyst represented by Formula 2 below, optimized for dry reforming reaction and which has a very high methane conversion rate. Thus, it allows to produce hydrogen gas (H₂) without deterioration of catalyst activity even though dry reforming reaction is used.

In one exemplary embodiment, the dry reforming reaction unit 100 may comprise a perovskite catalyst, specifically, a perovskite catalyst which is highly resistant to sulfur and carbon and whose activity for dry reforming reaction can be easily controlled through doping.

The perovskite catalyst may be a perovskite material represented by SrTiO₃ in which a part of strontium (Sr) is substitutionally doped with yttrium (Y) and a part of titanium (Ti) is substitutionally doped with ruthenium (Ru). That is, the perovskite catalyst may be a compound with the perovskite structure obtained by doping a part of the A-site (Sr) and a part of the B-site (Ti) in a perovskite material of the structure of ABO₃ with different materials from each other (Y into the A-site and Ru into the B-site).

For example, the perovskite catalyst may be a catalyst for biogas reforming comprising a compound represented by the following Formula 2:

Sr_{1-y}Y_{y}Ti₁₋ₓRuₓO_{3-δ} Formula 2

wherein x is greater than 0 and less than 1, y is greater than 0 and less than 0.1, and δ is 0 or more and 1 or less.

In exemplary embodiments, considering all of the maintenance of the single phase of the catalyst, prevention of carbon deposition and/or catalyst poisoning, maintenance of the catalyst activity, and improved electrical conductivity, the amount of ruthenium (Ru) substituted into the titanium site (B-site of the perovskite structure), that is, x in Formula 2 may preferably be greater than 0 and 1 or less (0<x≤1). Particularly, x may preferably be 0.05. In addition, the amount of yttrium (Y) substituted into the strontium site (A-site of the perovskite structure), that is, y in Formula 2 may preferably be greater than 0 and 0.08 or less (0<y≤0.08). Particularly, y may preferably be 0.08.

Meanwhile, in one exemplary embodiment, the partial doping of a perovskite material with yttrium (Y) and ruthenium (Ru) may be performed by the Pechini method among known methods for preparing dry reforming reaction catalysts, using distilled water or deionized water (DI water) as a solvent for dissolving compounds including yttrium (Y), strontium (Sr), titanium (Ti), and ruthenium (Ru).

In one embodiment, a catalyst may be used which is prepared by dip coating a compound represented by Formula 2 onto a monolith support (that is, a catalyst comprising a compound represented by Formula 2 supported on a monolith support).

In one exemplary embodiment, the catalyst for biogas reforming may achieve a methane conversion rate of 80% or more during an operation period of 100 to 150 hours at a temperature of 700 to 900° C.

Meanwhile, the perovskite catalyst may be prepared in the form of a pallet or a powder, which provides a large area for reaction with biogas to further increase the hydrogen production efficiency.

Meanwhile, as shown in Scheme 1, the dry reforming reaction is an endothermic reaction, and thus, the dry reforming reaction unit 100 should maintain an appropriate temperature (about 700 to 900° C.)

In one exemplary embodiment, the hydrogen production device may further comprise a preheater (not shown) between the supply unit and the dry reforming reaction unit 100. This prevents carbon deposition between the supply unit and the dry reforming reaction unit 100, allowing large-scale dry reforming reaction.

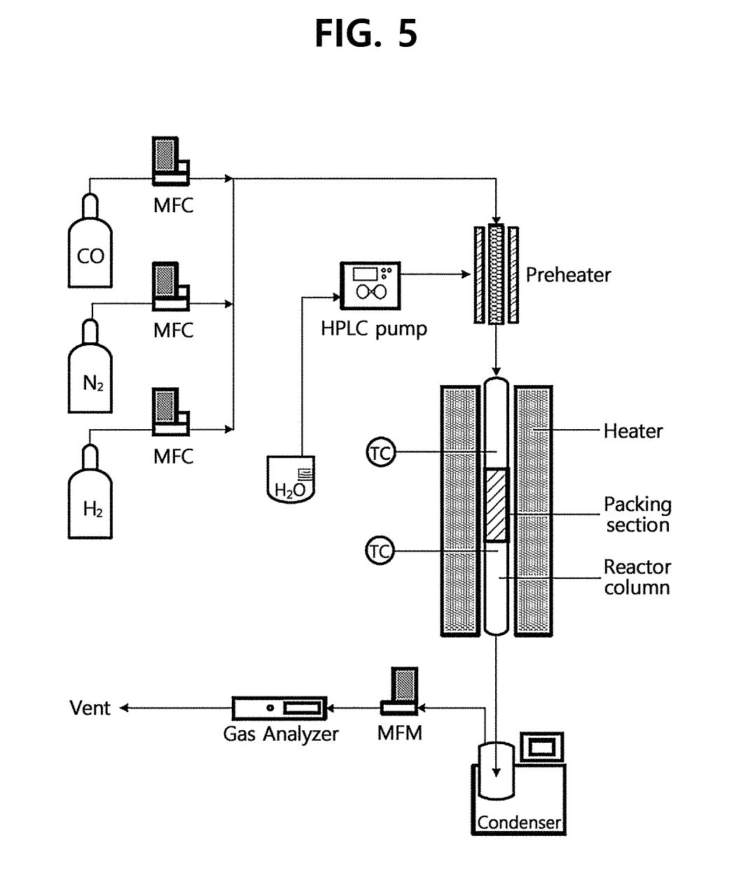

FIG. 4 shows an example of the dry reforming reaction unit 100. The Inconel tube in FIG. 4 is manufactured as a large reforming reactor and is used as a material for preventing the carbon deposition in the reactor part due to an increase of the biogas flow rate. The insulation wool is used to prevent blowing of catalyst powders due to the gas flow and to maintain the temperature of the place where catalysts are contained. The porous Inconel disk is designed to ensure that the catalysts in the reactor are held in a constant temperature zone and to allow gases to pass through easily after reaction.

The hydrogen production device further comprises a carbon dioxide transfer unit (not shown) for connecting the gas shift unit 200 and the dry reforming reaction unit 100 and transferring the carbon dioxide (CO₂) supplied from the gas shift unit 200 to the dry reforming reaction unit 100. That is, the carbon dioxide transfer unit enables to recycle carbon dioxide.

In general, the amount of carbon dioxide required for dry reforming reaction is determined by the ratio of CO₂ and CH₄, and the stoichiometric ratio is 1:1, as shown in Scheme 1 above. However, in general, the ratio of carbon dioxide to methane contained in biogas is 2:3, which is insufficient. Accordingly, carbon dioxide needs to be supplied separately in conventional methods.

However, in the present invention, carbon dioxide is produced and adsorbed in the gas shift unit 200 and the captured carbon dioxide can be continuously supplied to the dry reforming reaction unit 100 through the carbon dioxide transfer unit. Thus, dry reforming reaction can proceed without separate supply of carbon dioxide.

Meanwhile, the synthesis gas containing hydrogen and carbon dioxide produced in the dry reforming reaction unit is transferred to the gas shift unit 200 together with heat.

In the gas shift unit 200, the shift reaction of the synthesis gas containing carbon monoxide and the adsorption reaction of carbon dioxide occur. The gas shift unit 200 comprises a hydrogen production catalyst for promoting the shift reaction of a synthesis gas and an adsorbent for capturing carbon dioxide to carry out the adsorption reaction of carbon dioxide.

The synthesis gas shift reaction can be represented by the following Scheme 3:

CO+H₂O↔CO₂+H₂(ΔH_{298K}=−41 kJ mol⁻¹) Scheme 3

The synthesis gas shift reaction is also referred to as water-gas shift reaction. Here, carbon monoxide and steam react in the same molar ratio to produce hydrogen and carbon dioxide.

In one exemplary embodiment, a hydrogen production catalyst may be used to perform the synthesis gas shift reaction.

For example, the hydrogen production catalyst may be prepared to comprise at least one transition metal selected from the group consisting of Cu, Ni and Fe. In addition, the hydrogen production catalyst may further contain ZnO and/or Al₂O₃ as a cocatalyst and support.

In one embodiment, the hydrogen production catalyst may be a catalyst comprising at least one selected from the group consisting of CuO/ZnO/Al₂O₃ and Cu/ZnO/Al₂O₃.

Meanwhile, the gas shift unit 200 comprises an adsorbent for capturing carbon dioxide, whereby the carbon dioxide produced by the synthesis gas shift reaction can be adsorbed in the same reactor.

In one exemplary embodiment, the adsorbent for capturing carbon dioxide may comprise an alkali metal double salt-based adsorbent or a hydrotalcite-based adsorbent.

In one embodiment, the alkali metal double salt-based adsorbent is not limited as long as it is prepared by coprecipitation or impregnation method of an alkaline earth metal carbonate (K₂CO₃, Na₂CO₃), etc. However, for example, the alkali metal double salt-based adsorbent may comprise at least one selected from the group consisting of K₂Mg(CO₃)₂.4H₂O and KHMg(CO₃)₂.H₂O.

Alternatively, the alkali metal double salt-based adsorbent may be a carbon dioxide adsorbent comprising a double salt comprising a first metal salt comprising a first metal selected from magnesium (Mg), calcium (Ca), strontium (Sr), and barium (Ba); and a second metal salt comprising a second metal selected from lithium (Li), sodium (Na), potassium (K), rubidium (Rb) and cesium (Cs).

In one embodiment, the alkali metal double salt-based adsorbent may be a material based on a double salt of sodium and magnesium.

In one embodiment, the hydrotalcite-based adsorbent may be obtained by mixing a chloride represented by any one of the following Formulae 4 to 7 with a carbonate represented by the following Formula 8 and subjecting the resultant to hydrothermal synthesis or coprecipitation method:

(1−x)M(OH)₂ Formula 4

(1−x)M(NO₃)₂ Formula 5

xL(OH)₃ Formula 6

xL(NO₃)₃ Formula 7

(x/2)A₂CO₃ Formula 8

wherein x may be a number of 0.17 to 0.4, M may be selected from the group consisting of magnesium (Mg), zinc (Zn) and nickel (Ni), L may be selected from the group consisting of aluminum (Al), gallium (Ga), iron (Fe) and manganese (Mn), and A may be selected from the group consisting of sodium (Na), potassium (K), rubidium (Rb), cesium (Cs) and francium (Fr).

Meanwhile, the adsorbent for capturing carbon dioxide may further comprise a carbonate-based adsorbent, which can further enhance the adsorption performance.

In one embodiment, the adsorbent for capturing carbon dioxide may further comprise potassium carbonate (K₂CO₃).

For example, the adsorbent for capturing carbon dioxide may be a Mg/Al hydrotalcite-based adsorbent impregnated with K₂CO₃.

In general, the water-gas shift reaction represented by Scheme 3 is an exothermic reaction. In this reaction, the lower the reaction temperature is, the higher the carbon monoxide conversion rate is, but the slower the reaction rate is. However, in the present invention, carbon dioxide is adsorbed immediately after production in the same reactor, which promotes the forward reaction of the water-gas shift reaction, thereby overcoming the thermodynamic limitation of the catalytic reaction.

In one exemplary embodiment, the weight ratio of hydrogen production catalyst and the adsorbent for capturing carbon dioxide may be 1:9 to 9:1, specifically 1:4 to 4:1. They may be mixed in the reactor or already mixed separately. When the weight ratio of the hydrogen production catalyst and the adsorbent for capturing carbon dioxide exceeds 9:1, the catalytic reaction for hydrogen production may not proceed smoothly.

In one exemplary embodiment, the gas shift unit 200 may be appropriately controlled depending on the type of the catalyst and the adsorbent. For example, the temperature of the gas shift unit 200 may be maintained at a temperature of 200 to 500° C., specifically, at a temperature of 250 to 340° C.

The gas shift unit 200 may be further connected to a heat transfer unit 250 for transferring the waste heat of the dry reforming reaction unit 100 to the gas shift unit 200. The heat transfer unit 250 may further comprise a steam generator (not shown) for producing water vapor and a preheating unit (not shown) for preheating the synthesis gas produced in the dry reforming reaction unit. The preheating unit may be operated using the waste heat of the dry reforming reaction unit as a heat source.

In addition, although not shown, the gas shift unit 200 may be further connected to a hydrogen gas capturing unit for capturing the produced hydrogen gas, which allows to capture high purity hydrogen without a separate separation process.

The dry reforming reaction unit of the present invention comprises a catalyst optimized for dry reforming reaction. Thus, reforming reaction using a large amount of biogas can be carried out with high efficiency. In addition, the gas shift unit of the hydrogen production device of the present invention captures carbon dioxide immediately, which allows to maintain the hydrogen production performance in the gas shift unit without deterioration. Thus, the hydrogen production performance can be greatly improved.

Hydrogen Production Method

In another embodiment, the present invention provides a method for producing hydrogen using the same principle as the hydrogen production device. The method for producing hydrogen includes the same or similar constitution to the hydrogen production device, and thus detailed description thereof will be omitted.

The method for producing hydrogen comprises: the first step of, in a dry reforming reaction unit, directly reacting methane and carbon dioxide in biogas to produce a synthesis gas; and the second step of, in a gas shift unit, reacting carbon monoxide in the synthesis gas produced in the dry reforming reaction unit with water vapor to produce carbon dioxide and hydrogen and capturing the produced carbon dioxide.

In the first step, a perovskite catalyst may be used when directly reacting methane and carbon dioxide in biogas to produce a synthesis gas.

In the second step, the carbon dioxide captured from the reaction of carbon monoxide and water vapor may be recycled in the reaction with methane in biogas in the first step.

In one exemplary embodiment, the gas shift unit in which the second step is carried out may comprise a hydrogen production catalyst and an adsorbent for capturing carbon dioxide, and the weight ratio of the hydrogen production catalyst and the adsorbent for capturing carbon dioxide may be 1:9 to 9:1, specifically 1:4 to 4:1.

Meanwhile, the waste heat generated in the synthesis gas production in the first step may be recycled in the reaction of carbon dioxide and water vapor and the capture of hydrogen in the second step.

Hereinafter, the present invention will be described in more detail with reference to examples. It will be apparent to those skilled in the art that the examples are for illustrative purposes only and that the scope of the present invention is not construed as being limited by the examples.

### EXAMPLES

### Test Example 1: Preparation of Catalysts for Dry Reforming Reaction and XRD Analysis Determination Thereof

Preparation of Catalyst 1

3.064 g of yttrium nitrate (Y(NO₃)₃.H₂O; Aldrich) and 19.469 g of strontium nitrate (Sr(NO₃)₃.H₂O; Aldrich) were simultaneously dissolved in deionized water (DI water). After sufficiently dissolving 28.13 g of titanium isopropoxide (Ti(OCH(CH₃)₂)₄; Aldrich) and 76.8 g of citric acid in 200 g of ethylene glycol, 0.622 g of ruthenium chloride (Cl₃Ru.xH₂O; Junsei) was dissolved in deionized water (DI water) for stabilization. The solutions were mixed together at 80° C. for 24 hours to prepare a gel solution containing Sr_{0.92}Y_{0.08}Ti_{0.97}Ru_{0.03}O_{3-δ}(3% of Ru doped). Then, the resultant solution was dried at 110° C. and then heat-treated at 650° C. for 5 hours under air conditions. As a result, a catalyst comprising Sr_{0.92}Y_{0.08}Ti_{0.97}Ru_{0.03}O_{3-δ} was prepared.

Preparation of Catalyst 2

Catalyst 2 was prepared by the same process as Catalyst 1 except that heat treatment was carried out under the conditions of hydrogen and 900° C. for 5 hours instead of the conditions of air and 650° C.

Preparation of Catalyst 3

Catalyst 3 was prepared by the same process as Catalyst 1 except that ruthenium chloride (Cl₃Ru.xH₂O; Junsei) was not dissolved.

XRD Analysis

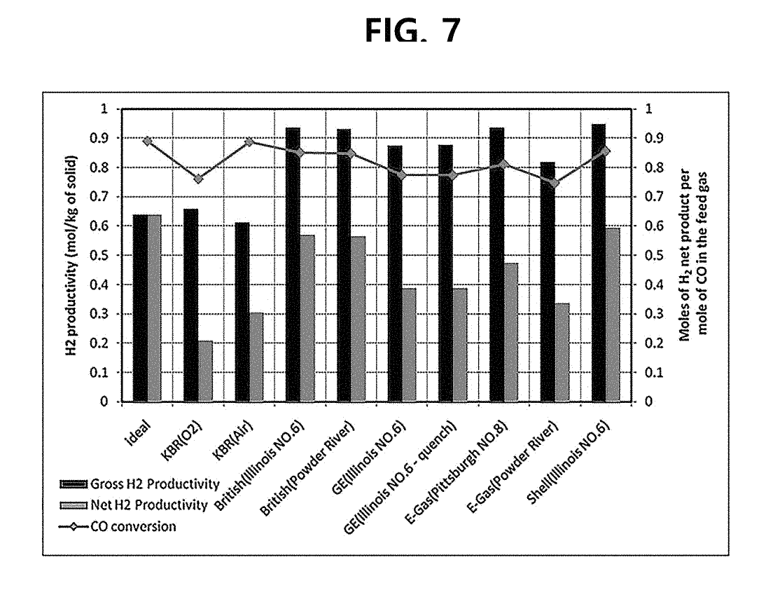

Then, in order to evaluate the composition of Catalysts 1 to 3, X-ray diffraction (XRD) analysis was performed for the catalysts. The results are as shown in FIG. 6.

With reference to FIG. 6, it can be understood that Catalysts 1 and 2 are a single-phase homogeneous catalyst having, as a basic structure, a perovskite structure of SrTiO₃ in which a part of strontium (Sr) is substantially doped with yttrium (Y) and a part of titanium (Ti) is substantially doped with ruthenium (Ru). It can also be seen that they can be easily prepared by the Pechini method using distilled water or deionized water, not ethanol, as a solvent.

### Test Example 2: Determination of the Adsorbent Performance

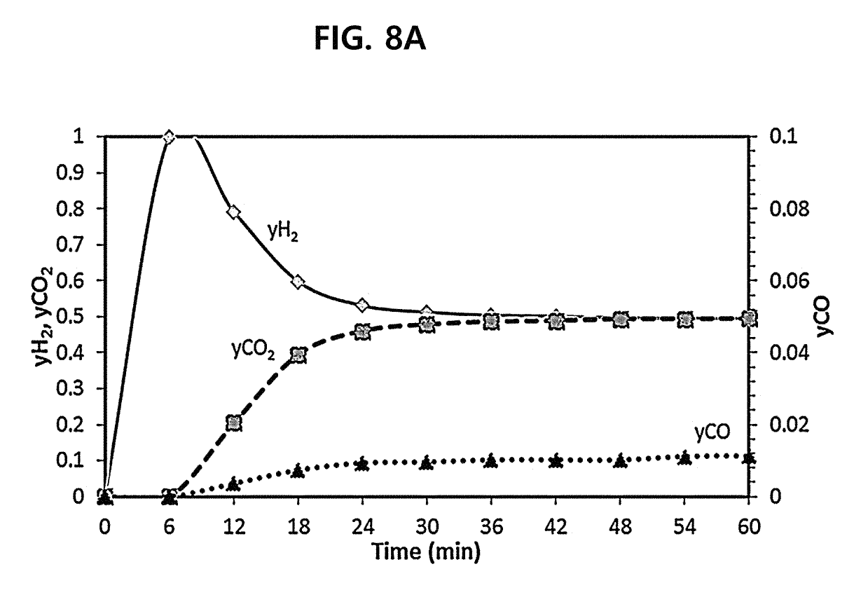

FIG. 7 numerically illustrates the results of the water-gas shift reaction of the different gas composition shown in Table 1 below using the gas shift unit (an adsorbent (Mg/Al hydrotalcite-based adsorbent impregnated with K₂CO₃)+a catalyst (a commercial catalyst having the composition of Cu/ZnO/Al₂O₃)), by using the MATLAB program. As shown in Table 1, synthesis gases coming from commercial gasifiers were found to have a lower CO conversion rate and a lower H₂ production rate than the ideal feed conditions because the impurities contained therein hinder the forward reaction of the water-gas shift reaction. However, most of the synthesis gases coming from commercial gasifiers were found to have a higher gross H₂ production rate than the ideal feed conditions.

TABLE 1

| | Commercial | | | | | |
|---|---|---|---|---|---|---|
| | gasifier manufacturer | yCO | yH₂ | yCO₂ | yinert | yH₂O |
| Gas 1 | ideal | 0.25 | | | | 0.75 |
| Gas 2 | KBR-Powder River | 0.08 | 0.132 | 0.134 | 0.414 | 0.24 |
| | Basin (Oxygen- | | | | | |
| | enriched Air) | | | | | |
| Gas 3 | KBR-Powder | 0.067 | 0.06 | 0.076 | 0.596 | 0.201 |
| | River Basin (Air) | | | | | |
| Gas 4 | British Gas Lurgi- | 0.207 | 0.113 | 0.016 | 0.043 | 0.621 |
| | Illinois No. 6 | | | | | |
| Gas 5 | British Gas Lurgi- | 0.209 | 0.115 | 0.017 | 0.032 | 0.627 |
| | Powder River Basin | | | | | |
| Gas 6 | GE(Texaco)- | 0.182 | 0.177 | 0.08 | 0.015 | 0.546 |
| | Illinois No. 6 | | | | | |
| | (Before quench) | | | | | |
| Gas 7 | GE(Texaco)- | 0.182 | 0.178 | 0.08 | 0.014 | 0.546 |
| | Illinois No. 6 | | | | | |
| | (After quench) | | | | | |
| Gas 8 | conocophillips E-Gas- | 0.196 | 0.155 | 0.046 | 0.015 | 0.588 |
| | Pittsburgh No. 8 | | | | | |
| Gas 9 | conocophillips E-Gas- | 0.174 | 0.186 | 0.105 | 0.013 | 0.522 |
| | Powder River Basin | | | | | |
| Gas 10 | Shell - | 0.213 | 0.108 | 0.008 | 0.032 | 0.639 |
| | Illinois No. 6 | | | | | |

In addition, from FIG. 7, it can be seen that when a mixture other than carbon dioxide and steam is contained, the conversion rate by a catalytic reaction is reduced based on the thermodynamic equilibrium principle, but that the hydrogen productivity is improved by the reaction with the adsorbent of the gas shift unit. Thus, it was found that the gas shift unit of the present invention achieved very excellent hydrogen production efficiency.

### Test Example 3: Determination of the Performance of the Gas Shift Unit

Manufacture of the Gas Shift Unit

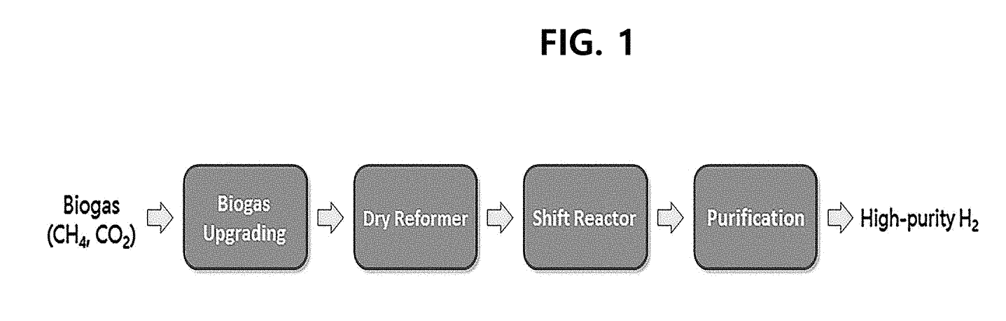

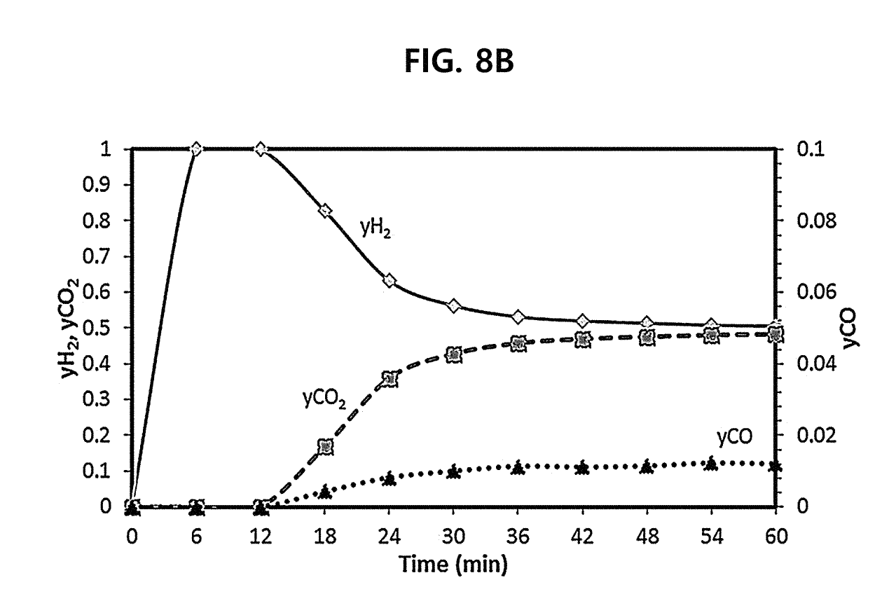

FIG. 8A and FIG. 8B show the test results of examples of sorption-enhanced water-gas shift reaction. A commercial hydrogen production catalyst (ShiftMax 210; Sud-Chemie (now Clarient)) with the composition of Cu/ZnO/Al₂O₃ and an adsorbent in which 35 wt % of potassium carbonate (K₂CO₃) is impregnated into a commercial hydrotalcite adsorbent (MG70, Sasol GmbH, Germany) were used. For this test, uniform mixtures of a catalyst and an adsorbent were prepared. The mixing ratio of the hydrogen production catalyst to the adsorbent was 4:1 and 1:4, respectively. Then, each of the mixtures was formed into cylindrical pellets, and filled into the gas shift unit. It was found that when the ratio of the catalyst to the adsorbent was 4:1 (FIG. 8A) and 1:4 (FIG. 8B), respectively, under the reaction conditions (300° C., 19 vol % CO, 57 vol % H₂O), the water-gas shift reaction normally proceeded with a commercial catalyst, and at the same time, high purity hydrogen was produced with removal of the carbon dioxide produced as a reaction byproduct by a hydrotalcite-based adsorbent. In addition, it was found that high purity hydrogen production time became longer when a larger amount of adsorbent was filled in the column.

### Test Example 4: Evaluation of the Performance of Connection Between the Dry Reforming Reaction Unit and the Gas Shift Unit

Connection Between the Dry Reforming Reaction Unit and the Gas Shift Unit

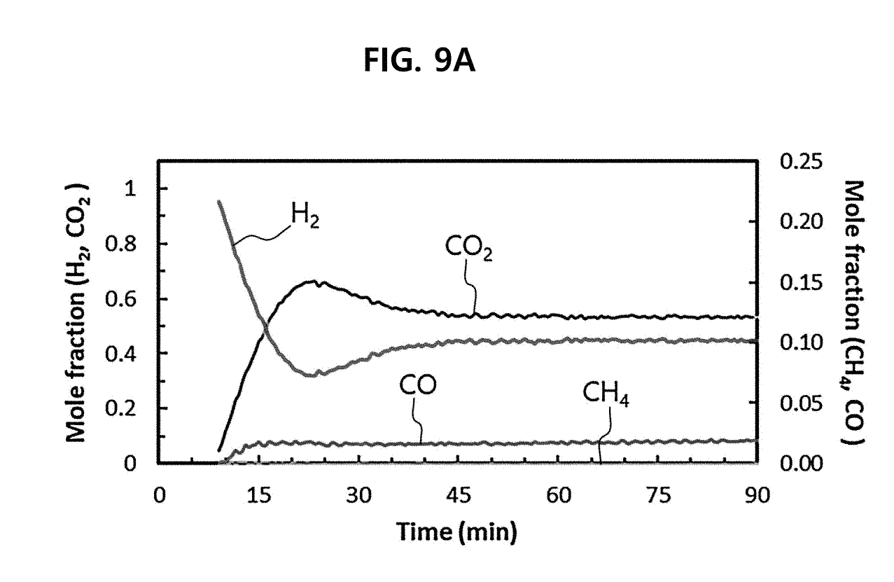

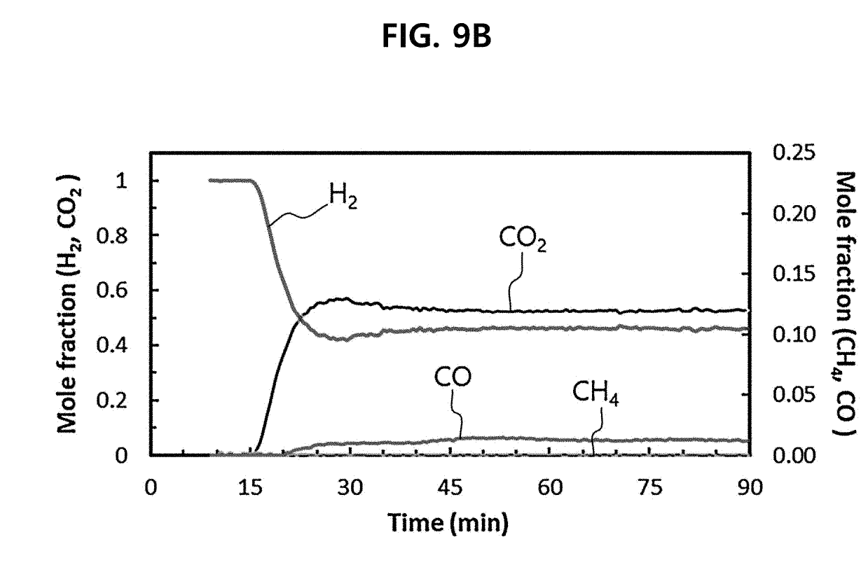

FIG. 9A and FIG. 9B show the test results of examples in which the dry reforming reaction unit and the gas shift unit are connected using methane and carbon dioxide contained in biogas. In this test, a Sr_{0.92}Y_{0.08}Ti_{0.95}Ru_{0.05}O_{3-δ} catalyst was used for the dry reforming reaction unit, and a commercial hydrogen production catalyst (ShiftMax 210; Süd-Chemie (now Clarient)) with the composition of Cu/ZnO/Al₂O₃ and an adsorbent in which 35 wt % of potassium carbonate (K₂CO₃) is impregnated into a commercial hydrotalcite adsorbent (MG70; Sasol GmbH, Germany) were filled into the gas shift unit. The ratio of the catalyst and the adsorbent filled into the gas shift unit was set to 1:4 by mass. For reaction, a mixed gas of methane and carbon dioxide at a ratio of 1:3 by volume was injected into the dry reforming reaction reactor and steam was further injected from the steam generator between the dry reforming reaction unit and the gas shift unit. The flow rate of steam was set to 3 times by volume of the amount of carbon monoxide that can be generated from the methane and carbon dioxide injected into the dry reforming reaction unit. The internal temperature of the dry reforming reaction unit and the gas shift unit were set to 800° C. and 300° C., respectively. The gases generated in the gas shift unit was passed through a condenser to remove all the contained moisture, and then the composition thereof was determined by using a gas analyzer. FIG. 9A shows a change in gas composition over time under the same reaction conditions when the two reactors are connected and when the gas shift unit does not include an adsorbent. From the results, it can be seen that the carbon monoxide produced in the dry reforming reaction unit is further converted into carbon dioxide and hydrogen in the gas shift unit. In contrast, from the results of the case where the gas shift unit includes an adsorbent (FIG. 9B), it was found that both the carbon dioxide contained in the exhaust gas of the dry reforming reaction unit and the carbon dioxide additionally generated as a reaction byproduct in the gas shift unit were removed by the included hydrotalcite-based adsorbent, and at the same time that high purity hydrogen was produced during the same time period. The concentration of hydrogen produced during the sorption-enhanced reaction time was about 99.95%, and no byproduct gas was detected other than the unreacted methane in the dry reforming reaction unit. Thus, it was found that the hydrogen production device in which the dry reforming reaction unit and the gas shift unit were connected was excellent in the efficiency of producing high purity hydrogen.

The examples of the present invention described above should not be construed as limiting the technical idea of the present invention. The scope of protection of the present invention is limited only by the matters described in the claims, and those skilled in the art will be able to modify the technical idea of the present invention in various forms. Accordingly, such improvements and modifications will fall within the scope of the present invention as long as they are obvious to those skilled in the art.

What is claimed is:

1. A hydrogen production device comprising: a dry reforming reaction unit for directly reacting methane and carbon dioxide in biogas to produce a synthesis gas containing hydrogen; and
a gas shift unit for reacting carbon monoxide in the synthesis gas produced in the dry reforming reaction unit with water vapor to produce carbon dioxide and hydrogen, and for capturing the produced carbon dioxide.

2. The hydrogen production device according to claim 1,
wherein the carbon dioxide captured in the gas shift unit is supplied to the dry reforming reaction unit to be recycled in the reaction with methane in biogas.

3. The hydrogen production device according to claim 1,
wherein the gas shift unit comprises a hydrogen production catalyst and an adsorbent for capturing carbon dioxide, and
wherein the weight ratio of the hydrogen production catalyst and the adsorbent for capturing carbon dioxide is 1:9 to 9:1.

4. The hydrogen production device according to claim 1,
wherein the hydrogen production catalyst comprises at least one transition metal selected from the group consisting of Cu, Ni, and Fe.

5. The hydrogen production device according to claim 1,
wherein the adsorbent for capturing carbon dioxide comprises an alkali metal double salt-based adsorbent or a hydrotalcite-based adsorbent.

6. The hydrogen production device according to claim 5,
wherein the alkali metal double salt-based adsorbent is an adsorbent prepared by coprecipitation or impregnation process of an alkaline earth metal carbonate, and
the hydrotalcite-based adsorbent is an adsorbent prepared by mixing a chloride represented by any one of the following Formulae 1 to 4 and a carbonate represented by the following Formula 5 and subjecting the resultant to hydrothermal synthesis or coprecipitation:
(1−x)M(OH)₂ Formula 1
(1−x)M(NO₃)₂ Formula 2
xL(OH)₃ Formula 3
xL(NO₃)₃ Formula 4
(x/2)A₂CO₃ Formula 5
wherein x is a number of 0.17 to 0.4, M is selected from the group consisting of magnesium (Mg), zinc (Zn) and nickel (Ni), L is selected from the group consisting of aluminum (Al), gallium (Ga), iron (Fe) and manganese (Mn), and A is selected from the group consisting of sodium (Na), potassium (K), rubidium (Rb), cesium (Cs) and francium (Fr).

7. The hydrogen production device according to claim 1,
wherein the dry reforming reaction unit comprises a catalyst comprising a compound represented by the following Formula 6:
Sr_{1-y}Y_{y}TiRuₓO_{3-δ} Formula 6
wherein x is greater than 0 and less than 1, y is greater than 0 and less than 0.1, and δ is 0 or more and 1 or less.

8. The hydrogen production device according to claim 7,
wherein the catalyst comprising the compound represented by Formula 6 achieves a methane conversion rate of 80% or more during an operation period of 60 to 120 hours at a temperature of 700 to 900° C.

9. The hydrogen production device according to claim 1,
wherein the hydrogen production device further comprises a heat transfer unit for transferring the waste heat of the dry reforming reaction unit to the gas shift unit, and
the heat transfer unit comprises: a steam generator for producing water vapor; and a preheating unit for preheating the synthesis gas produced in the dry reforming reaction unit.

10. The hydrogen production device according to claim 9,
wherein the preheating unit is operated using the waste heat of the dry reforming reaction unit as a heat source.

11. The hydrogen production device according to claim 1, further comprising a hydrogen gas capturing unit connected to the gas shift unit.

12. A method for producing hydrogen by means of a hydrogen production device comprising a dry reforming reaction unit and a gas shift unit, the method comprising:
in the dry reforming reaction unit, directly reacting methane and carbon dioxide in biogas to produce a synthesis gas; and
in the gas shift unit, reacting carbon monoxide in the synthesis gas produced in the dry reforming reaction unit with water vapor to produce carbon dioxide and hydrogen, and capturing the produced carbon dioxide.

13. The method according to claim 12,
wherein the carbon dioxide captured from the reaction of carbon monoxide and water vapor is recycled in the reaction with methane in biogas in the dry reforming reaction unit.

14. The method according to claim 12,
wherein the gas shift unit comprises a hydrogen production catalyst and an adsorbent for capturing carbon dioxide, and
wherein the weight ratio of the hydrogen production catalyst and the adsorbent for capturing carbon dioxide is 1:9 to 9:1.
